(19) United States
(12) Patent Application Publication
(10) Pub. No.: US 2015/0358273 A1
(43) Pub. Date: Dec. 10, 2015

(54) REQUEST FOR INFORMATION SYSTEM

(71) Applicant: Rebecca Lee FEINSTEIN, Brookville, NY (US)

(72) Inventor: Rebecca Lee FEINSTEIN, Brookville, NY (US)

(21) Appl. No.: 14/297,732

(22) Filed: Jun. 6, 2014

(51) Int. Cl. H04L 12/58; H04L 29/08

(52) U.S. Cl. CPC H04L 51/32; H04L 67/22

(57) ABSTRACT

A request for information system is provided. The request for information system may include at least one computer with a user interface and a program product adapted to provide user-generated elicited information through a question-and-answer forum organized by location. A user may select at least one current location or a custom location of interest. Then the user may subscribe to at least one localized list associated with the selected location of interest. Then the user may select a topic such as food, drink, culture or the like from the localized list. The program product may display the most relevant user-generated requests and elicited information that match the location and or the topics selected. At which point, a user may view such requests and elicited information or submit a new request. If the user submits a request, the program product may provide similar requests based on similarity in topic and location associated with the new request. The user may choose from the provided similar requests for viewing or the user may post their submitted request for other users to generate elicited information. In any event, the program product may provide elicited information in response. The provided elicited information may be ranked by the highest number of positive votes less negative votes. Subsequently, the program product may notify the user of any newly added requests and or elicited information related to requests the user has indicated through the steps disclosed herein.

### BACKGROUND OF THE INVENTION

The present invention relates to data processing and, more particularly, to methods and systems for organizing a question-and-answer service by location.

Access to travel information through search engines is limited in how personalized and localized it can be. Currently, travel information is gathered through a wide net, providing only general city-wide information, such as by applying search terms to a city-wide field, as opposed to information prioritized by specified locations and personalized tastes. Moreover, question-and-answer services typically mix personalized information with sponsored information, and thus the search results is cluttered with what sponsors have paid to have presented.

As a result, such information's relevancy is adulterated by sponsored content and content outside the user's geographical interest. And so users cannot find places and answers that are most relevant to them. Nor can they satisfactorily answer questions for other users in their vicinity. Making it unnecessarily difficult for people to both explore the places they live in and travel through and help others do the same.

As can be seen, there is a need for a system that provides question-and-answer format search results limited to user-generated and user-approved content and tailored to user-specified locations.

### SUMMARY OF THE INVENTION

In one aspect of the present invention, a system for organizing a request-and-answer online forum, comprises: a computer having a user interface; and a program product comprising machine-readable program code for causing, when executed, the computer to perform the following process steps: participating with at least one other program product user to form the request-and-answer online forum comprising protocols for communicating with each other so as to share a plurality of requests and a plurality of elicited information in the request-and-answer online forum; prompting a first user for an associated geographical area; receiving user-inputted associated geographical area from the first user; receiving a request from the first user regarding at least one topic; identifying at least one elicited information pertaining to the associated geographical area, wherein the at least one elicited information is in the request-and-answer online forum; and electronically representing the at least one elicited information related to the at least one topic on the first user interface.

In another aspect of the present invention, a method of providing a request-and-answer online forum that is user-generated and geographically significant, comprises: providing the request-and-answer online forum comprising protocols for communicating among a plurality of user so as to share a plurality of user-generated requests and a plurality of user-generated elicited information; selecting a localized area; subscribing to at least one localized list inclusive of at least a portion of the localized area; communicating a request having at least one topic page item in the request-and-answer online forum; and receiving electronic representations of at least one elicited information pertaining to the localized area and the at least one topic item page.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention;

FIG. 2 is a schematic view of an exemplary embodiment of the present invention;

FIG. 3 is a schematic view of an exemplary embodiment of the present invention; and FIG. 4 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a request for information system. The request for information system may include at least one computer with a user interface and a program product adapted to provide user-generated elicited information through a question-and-answer forum organized by location. A user may select at least one current location or a custom location of interest. Then the user may subscribe to at least one localized list associated with the selected location of interest. Then the user may select a topic such as food, drink, culture or the like from the localized list. The program product may display the most relevant user-generated requests and elicited information that match the location and or the topics selected. At which point, a user may view such requests and elicited information or submit a new request. If the user submits a request, the program product may provide similar requests based on similarity in topic and location associated with the new request. The user may choose from the provided similar requests for viewing or the user may post their submitted request for other users to generate elicited information. In any event, the program product may provide elicited information in response. The provided elicited information may be ranked by the highest number of positive votes less negative votes. Subsequently, the program product may notify the user of any newly added requests and or elicited information related to requests the user has indicated through the steps disclosed herein.

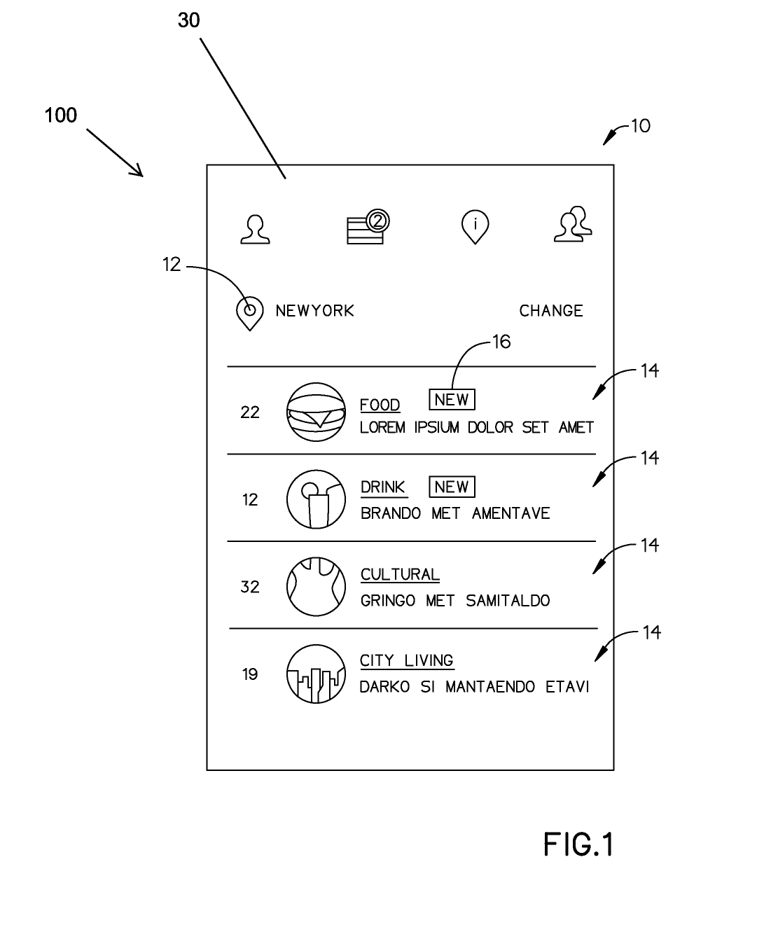

Referring to FIGS. 1 through 3, the present invention may include a request for information system 100. The request for information system 100 may include at least one computer with a user interface 10. The computer may include at least one processing element and a form of memory, including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The request for information system 100 may prompt users to set up an account. The request for information system 100 may prompt the user to provide account information, such as a name, email, relevant locations, demographic information and the like, that may be stored and/or otherwise associated with the account for identifying and other purposes. The request for information system 100 may provide password and authentications controls. The request for information system 100 may allow users to associate an image 26 to represent the user when their content is displayed on the user interface 10. The request for information system 100 may provide a location-based on-line forum. The on-line forum may be configured to generate, receive, store and transmit electronic representations of content user provides through the user interface 10. The content may include a plurality of requests for information 20 and a plurality of elicited information 22. The request-and-answer online forum may comprise protocols for communication between computers and/or program products so as to share a plurality of requests and elicited information in the request-and-answer online forum.

Each elicited information 22 may be associated with at least one request 20, and the elicited information 22 may include, but not be limited to, answers, inquiries, images, videos, text, ratings and/or votes responsive to the at least one request 20. The request for information system 100 forum may enable users to review and search requests 20 and elicited information 22 posted by other users. The request for information system 100 may be configured to associate at least one request 20 and associated elicited information 22 with at least one geographical area. In certain embodiments, the at least one geographical area may be defined by users by setting a specific radius from an identifiable location, such as a physical address, a zip code, a notable location like an airport, landmark or the like. The request for information system 100 may associate all requests 20 and elicited information 22 referencing a geographical area to a unique localized list. The localized list may be represented by a location icon 12 on the user interface 10.

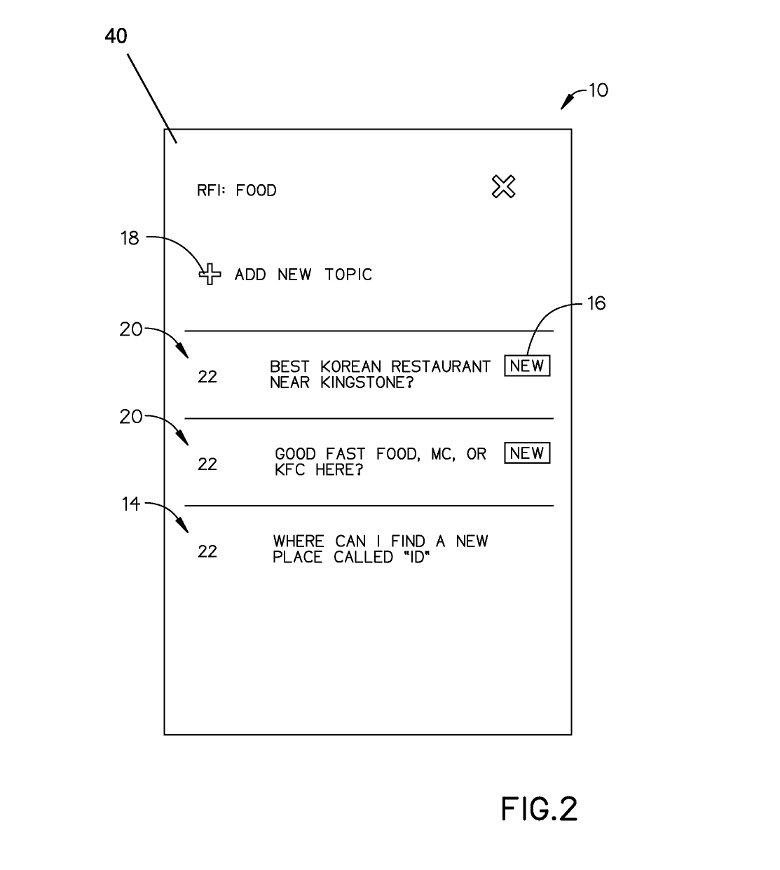

The request for information system 100 may generate an individual web page showing at least one request 20 and elicited information 22 related to the associated geographical area of a localized list—i.e., a localized page 30, as illustrated in FIG. 1. Within each localized page 30, a user may select from a group of different topics 14 (for example, Food, Cultural, Business, Drinks, International, Local Events, Social, General and or Miscellaneous.) that may be tailored for each specific localized page 30. The request for information system 100 may generate an individual web page showing at least one request 20 and elicited information 22 related to each topic 14—i.e., a topic page 40, as illustrated in FIG. 2. Each topic page 40 may be provided within each localized page 30 so as to view requests 20 and elicited information 22 other users have posted when in that geographic area under that topic 14. The user may then answer any request 20s, vote on any elicited information 22 given, submit a new requests inquiry to find related requests 20 and/or post their own new requests 20.

A user may “subscribe” to at least one localized list. By “subscribing” to at least one localized list, a user may be automatically informed by the request for information system 100 of requests 20 and elicited information 22 pertaining to the desired geographical area associated with said localized list. This may be done by notifications 16 sent to the user's account and/or an email associated with the user's account information. If, for example, user A subscribes to the localized list associated with Crete, when user B posts a request 20 or elicited information 22 pertaining to the Crete, then user A will be notified by notification 16 of user B's posting activity. The request for information system 100 may enable users to narrow the subscription to selected topics 14 whereby notifications 16 are generated.

In certain embodiments, the program product may determine the location of a computer utilizing the request for information system 100. Most computers, especially mobile devices, may have built-in navigational components, such as an accelerometer, a gyroscope, magnetometer and global positioning systems (GPS). The program product may continuously determine the location of the computer, in motion or at rest, by filtering the navigational components of the computer. In certain embodiments, a user may be subscribed to localized lists automatically be bringing their computer within the geographically area associated to such localized list. In certain embodiments, the request for information system 100 may organize the requests 20 and/or the elicited information 22 by the geographical area from which they originated, as defined by the GPS of the computer that enabled said requests 20 and/or the elicited information 22. So that if, as way of example, a user posted a request 20 from a computer located in Belize City, the request for information system 100 may associate that request 20 with at least one localized list approximately defining Belize City.

The request for information system 100 may provide a search function. The search function may retrieve requests 20 and elicited information 22 related to a posted request 20. If, for example, the user posts their own question, the program product may retrieve and present any similar request 20 and elicited information 22 having been asked in the subscribed localized list. Retrieval of requests 22 and elicited information 22 may be based on topic 14 or the like. The request for information system 100 may include a ranking mechanism. The request for information system 100 may provide a voting bar 24 for user rankings/votes. The ranking mechanism may “score” elicited information 22 based on votes. The elicited information 22 with the highest number of plus (+) vote points, less minus (−) vote points, may be placed at the top of the localized page 30 and or the topic page 40.

Referring to FIG. 4, a method 200 of using the present invention may include the following. The request for information system 100 disclosed above may be provided. The request for information system 100 may be performed by a computer. Method 200 begins at step 210 when the user opens and beings using the program product. In step 220 the user may select a current location as determined by the physical location of the computer and/or the user selecting a custom location. If the user selects a custom location, they may use their computer's map features, browse using HTML5, or the like to select a customized location, in step 230. Selection of location may subscribe the user to at least one localized list associated with the location and or geographical area submitted. Such location list may include it own localized page 30. Then in step 240, the user may select a topic 14 such as food, drink, culture or the like from the localized list. Each topic 14 may include it own topic page 40 nested with the localized page. In step 250, the topic page 40, localized page 30, and or localized list may display the most relevant user-generated requests 20 and elicited information 22 that match the location and or topics 14 selected. At which point, a user in step 260 may view such requests 20 and elicited information 22 or submit a new request 20.

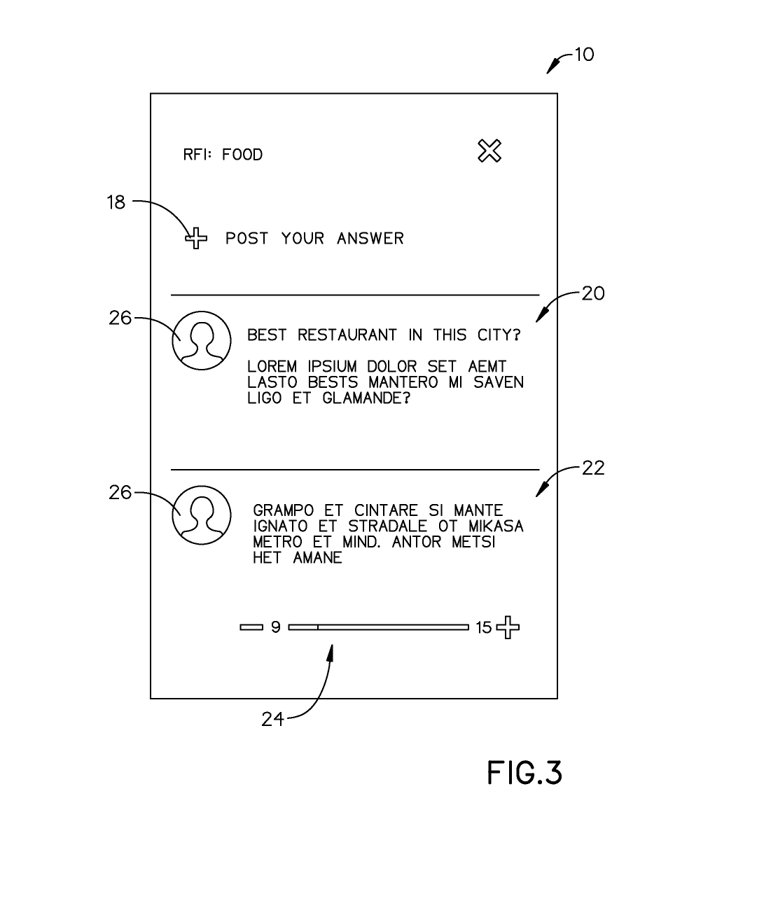

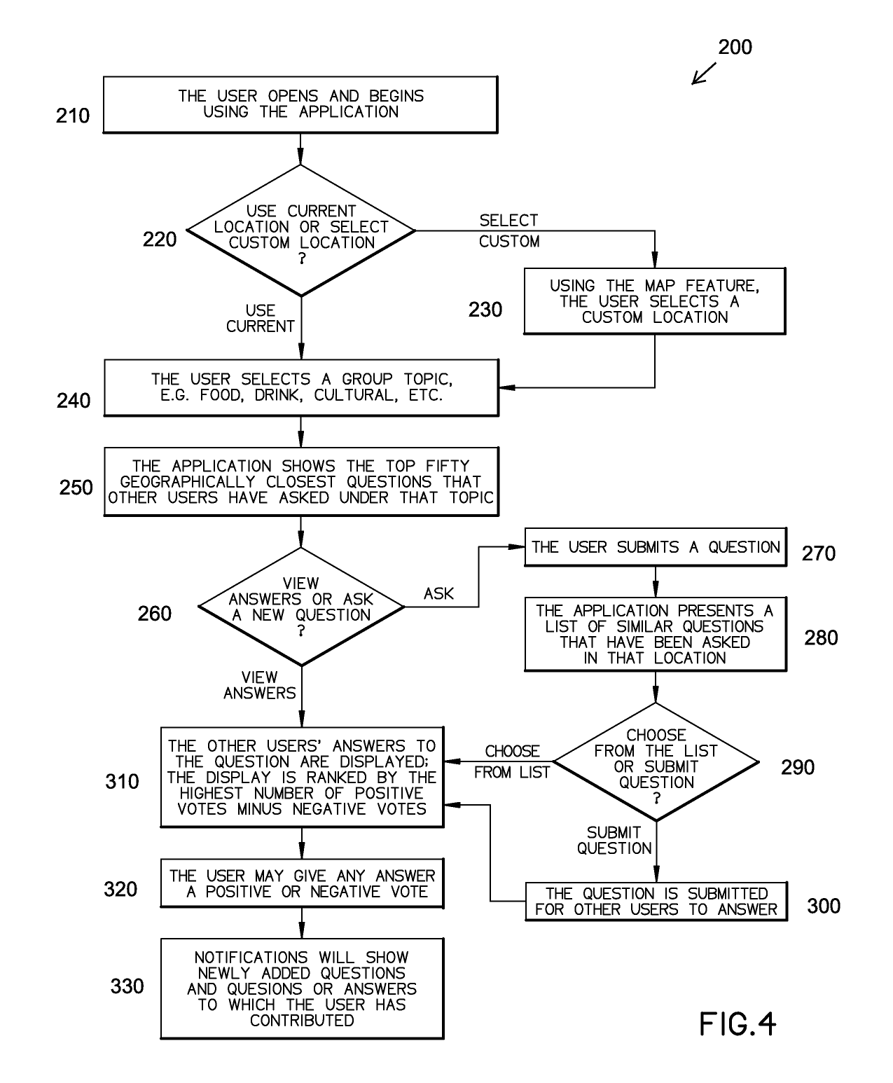

If the user submits a request 20, in step 270, the request for information system 100 may provide similar requests 20 based on similarity in topic 14 and location associated with the new request 20, step 280. The user may choose from the provided similar requests 20 for viewing, step 290, or they may post their submitted request 20 for other users to generate elicited information 22, by for example clicking an add request button 18, in step 300. In any event, the request for information system 100 may provide elicited information 22 in response to relevant user-generated requests 20 from step 250, similar requests 20 from step 290 and or the posted submitted request 20 from step 300. The provided elicited information 22 may be ranked by the highest number of positive votes less negative votes. In step 320, the user may rank and or vote for the elicited information 22 displayed in step 310, as illustrated in FIG. 3. Subsequently, in step 320, the request for information system 100 may notify the user of any newly added requests 20 and or elicited information 22 related to requests 20 the user has indicated through steps 260 through 310.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for organizing a request-and-answer online forum, comprising:
a computer having a user interface; and
a program product comprising machine-readable program code for causing, when executed, the computer to perform the following process steps:
participating with at least one other program product user to form the request-and-answer online forum comprising protocols for communicating with each other so as to share a plurality of requests and a plurality of elicited information in the request-and-answer online forum;
prompting a first user for an associated geographical area;
receiving user-inputted associated geographical area from the first user;
receiving a request from the first user regarding at least one topic;
identifying at least one elicited information pertaining to the associated geographical area, wherein the at least one elicited information is in the request-and-answer online forum; and
electronically representing the at least one elicited information related to the at least one topic on the first user interface.

2. The system of claim 1, further including prompting the first user to define at least one topic page item.

3. The system of claim 1, further including electronically representing at least one elicited information related to the associated geographical area and the at least one topic page item.

4. The system of claim 1, further including prompting the first user to specify a localized area; generating at least one localized list associated with the localized area; and prompting a plurality of users to subscribe thereto.

5. The system of claim 4, further including identifying a physical location of the computer of each user; and assigning each user to the at least one localized list incorporating the localized area that is at least inclusive of a portion the physical location.

6. The system of claim 4, further including electronically representing at least one elicited information related to the at least one topic page item to all subscribers of each localized lists.

7. The system of claim 1, further including providing a ranking mechanism for ranking the at least one elicited information.

8. The system of claim 1, further including electronically representing the ranking of the at least one elicited information in combination thereof.

9. The system of claim 4, further including notifying the first user when the at least one elicited information in the request-and-answer online forum pertains to the localized area and at least one topic page item.

10. A method of providing a request-and-answer online forum that is user-generated and geographically significant, comprising:
providing the request-and-answer online forum comprising protocols for communicating among a plurality of user so as to share a plurality of user-generated requests and a plurality of user-generated elicited information;
selecting a localized area;
subscribing to at least one localized list inclusive of at least a portion of the localized area;
communicating a request having at least one topic page item in the request-and-answer online forum; and
receiving electronic representations of at least one elicited information pertaining to the localized area and the at least one topic item page.

11. The method of claim 10, further including submitting a new request.

12. The method of claim 11, further including electronically representing at least one similar request pertaining to the localized area.

13. The method of claim 12, further including selecting from the at least one similar request; and electronically representing the at least one elicited information associated with the similar request.

14. The method of claim 13, further including submitting the new request.

15. The method of claim 14, further including electronically representing the at least one elicited information pertaining to the new request.

16. The method of claim 10, wherein the electronically representation of the representing the at least one elicited information are ranked by users.

17. The method of claim 16, further providing a ranking mechanism for ranking the at least one elicited information.

18. The method of claim 10, further including providing a notification of at least one elicited information in the request-and-answer online forum that pertains to the localized area and the at least one topic item page
